(19) United States
(12) Patent Application Publication
(10) Pub. No.: US 2016/0271575 A1
(43) Pub. Date: Sep. 22, 2016

(54) APPARATUS AND METHOD FOR HIGH-SHEAR MIXING

(71) Applicant: Silverson Machines Limited, Buckinghamshire (GB)

(72) Inventors: Richard BERGER, Chesham (GB); Peter MATTHEWS, Hazlemere (GB)

(21) Appl. No.: 15/074,228

(22) Filed: Mar. 18, 2016

(30) Foreign Application Priority Data
Mar. 20, 2015 (GB) 1504800.2

(51) Int. Cl. B01F 7/00; B01F 5/10; B01F 3/12

(52) U.S. Cl. CPC B01F 7/008; B01F 3/1221; B01F 5/104; B01F 3/1207

(57) ABSTRACT

Apparatus and method for high-shear mixing of a fluid includes a mixing assembly, optionally including a rotor and a stator; and an inducer arranged to be in-line with and upstream of the mixing assembly, whereby a fluid to be mixed can pass the inducer before reaching the mixing assembly.

### CROSS REFERENCE TO RELATED APPLICATIONS

The entire disclosure of GB 1504800.2 filed Mar. 20, 2015 is expressly incorporated by reference herein.

### FIELD

The present invention relates to an apparatus and method for high-shear mixing. In particular, the present invention aims to provide an apparatus and method for mixing a component into a fluid. Even more particularly, the present invention aims to provide an apparatus for mixing a powder into a liquid.

### SUMMARY

According to an aspect of the invention there is provided an apparatus for high-shear mixing of a fluid, comprising: a mixing assembly, optionally including a rotor and a stator; and an inducer arranged to be in-line with and upstream of the mixing assembly, whereby a fluid to be mixed can pass the inducer before reaching the mixing assembly.

By arranging an inducer to be in-line with and upstream of a rotor-stator mixing assembly in this way, mixing performance can be improved and powder can be absorbed at a rapid rate such that a consistent and agglomerate free mixture can be obtained. A particularly beneficial advantage of the inducer is that it can reduce the effect of cavitation in the fluid.

A fluid conduit may be provided, the fluid conduit preferably being arranged to introduce fluid into the mixing assembly, preferably via the inducer, and preferably along a generally horizontal flow path. For example, the apparatus may be arranged to rest on its supports such that the fluid conduit is generally horizontal. The fluid conduit may be further arranged to introduce a component, to be mixed with the fluid, into the fluid upstream of the inducer, preferably via a gravitational feed. A hopper may be provided, wherein the hopper is preferably arranged to introduce the component into the fluid conduit. The component to be mixed with the fluid is preferably a powder.

The fluid conduit is arranged to introduce a component into the fluid immediately upstream of the inducer, and preferably at a distance from the inducer that is less than about double the length of the inducer. The component is preferably arranged to be introduced into the fluid conduit at a position that is spaced from the ends of the fluid conduit.

The inducer may be a helical inducer or a scroll inducer, for example. The inducer may be coaxial with the mixing assembly. The inducer and rotor may be arranged to be rotated in unison.

Preferably, a shaft is provided, wherein rotor is mounted to the shaft so as to be rotatable relative to the stator, preferably for the purpose of mixing the fluid. A motor may be arranged to drive the shaft. The inducer may also be mounted onto the shaft. Alternatively, the rotor may comprise a stub axle onto which the inducer may be mounted. The axle stub arrangement may be beneficial for larger machines, for which it may not be possible physically to mount the inducer directly onto the shaft.

The apparatus may further comprise a housing for the mixer assembly, the housing having a fluid inlet and a fluid outlet, preferably with a fluid path provided therebetween. The mixing assembly may be arranged or disposed (within the housing), between the inlet and outlet.

The inducer may be disposed in the housing. Preferably, the inducer is arranged in the inlet of the housing. A housing assembly could comprise a separate casing and inlet body, or the casing and inlet body could be combined as a single component.

Preferably, the mixing assembly and inducer are both arranged within the housing such that the inducer is upstream of the mixing assembly with respect to the fluid inlet. The inducer is positioned at the fluid inlet of the housing. The fluid conduit is fluidly connected to the fluid inlet of the housing. Preferably, the fluid conduit is attached directly to the fluid inlet of the housing.

A component inlet may be arranged, preferably as part of the fluid conduit, to introduce a component into the fluid at a point upstream of the inducer, preferably wherein the distance between the housing inlet and/or tip of the inducer and a midpoint of the component inlet inducer is at least twice the length of the inducer, preferably at least triple the length of the inducer, or preferably at least quadruple the length of the inducer, or even more preferably at least five times the length of the inducer.

Alternatively, a component inlet may be arranged to introduce a component into the fluid at a point upstream of the inducer that is less than twice the length of the inducer, preferably wherein the distance between the housing inlet and/or tip of the inducer and a midpoint of the component inlet is between twice the length of the inducer and a third of the length of the inducer, more preferably wherein the distance is between 1.5 times the length of the inducer and half the length of the inducer, and even more preferably wherein the distance is roughly equal to the length of the inducer.

Preferably, the length of the inducer is measured from its tip to its rearmost blade/vane.

Alternatively a component inlet may be spaced from the inducer by a distance between half the diameter of the fluid conduit and/or the housing inlet and twice the diameter of the fluid conduit and/or the housing inlet, and more preferably by a distance roughly equal to the diameter of the fluid conduit and/or the housing inlet. The component inlet may be arranged such that it can receive a gravitational feed, in use.

The fluid conduit preferably has a first end arranged to receive a fluid and a second end arranged to be fluidly connected to the housing inlet, wherein the component inlet is arranged to introduce a component into the fluid conduit at a point between the first end and the second end. The second end of the fluid conduit may be attached to the housing inlet. The fluid conduit may be described as a “swept T-piece”, with the component inlet having a curved configuration at its point of connection to the fluid conduit, in the direction of the intended flow. Preferably, the fluid conduit and/or inducer is/are arranged generally horizontally, in use.

Alternatively, the inlet body of the housing may comprise a port that extends to provide a fluid conduit into which a component may be introduced into a fluid flow upstream of the inducer via a component inlet.

The rotor may be provided with one or more features, such as blades or vanes, for creating shear in a fluid passing through the mixing assembly when the rotor is rotated relative to the stator. The rotor may have an arrangement of blades configured to rotate within the stator, thereby to create a high-shear mixing effect. The rotor may also have an arrangement of blades configured to rotate about the stator, i.e. outside of the stator, thereby to create a pumping effect. Such a rotor with both an inner and an outer arrangement of blades may be called a “pumping rotor”, for example. A rotor may be rotated at speeds of about 3,000 rpm to about 3,600 rpm, for example.

The stator may be provided with one or more features, such as apertures, which may be angled, for creating shear in a fluid passing through the mixing assembly when the rotor is rotated relative to the stator.

The housing may further comprise a fluid outlet through which a fluid mixed inside the housing can be expelled. A source of fluid may be arranged to supply fluid to the housing. The source of fluid may be a fluid reservoir. The mixed fluid expelled from the housing may be returned to the reservoir or pumped onwards to the next processing stage.

Typically, a liquid will absorb as much powder as possible as fast as possible, but a metering valve may be used to control the amount and/or rate of powder being introduced into a liquid.

According to another aspect of the invention there is provided a method for high-shear mixing of a fluid, comprising: providing a mixing assembly, optionally including a rotor and a stator; and providing (or arranging) an inducer in-line with and upstream of the mixing assembly, whereby a fluid to be mixed can pass the inducer before reaching the mixing assembly.

A fluid conduit may be provided to introduce the fluid into the mixing assembly, preferably via the inducer. A component to be mixed with the fluid may be introduced into the fluid at a point upstream of the inducer.

The fluid may be arranged to flow along a generally horizontal flow path immediately prior to the component being introduced into the fluid and continuing the generally horizontal flow path to the inducer, and preferably past the inducer and into the mixing assembly.

The component may be introduced into the fluid via a gravitational feed. The component may be introduced into the fluid immediately upstream of the inducer. Preferably, the component is introduced into the fluid at a distance from the inducer that is less than about double the length of the inducer.

The inducer may be a helical inducer. The inducer and rotor may be rotated in unison. The inducer and rotor may be mounted to a common rotatable shaft.

The component to be mixed into the fluid may be a powder, and the fluid may be a liquid. The method may use an apparatus as described above.

According to another aspect of the invention there may also be provided a system for high-shear mixing of a fluid, comprising: an apparatus as described above; and a powder for mixing with the fluid.

A fluid reservoir may be connected in fluid communication with the apparatus so as to supply fluid for mixing with the powder.

The invention may be particularly beneficial for mixing a high viscosity component into a low viscosity component, for example a high viscosity powder into a low viscosity fluid, or vice versa. Similarly, it may be particularly beneficial for mixing two fluids of greatly differing viscosities.

A particularly beneficial application of the invention may be for mixing of powders (e.g. component) into liquids (e.g. fluids). By arranging an inducer upstream of a rotor-stator in a (preferably in-line) mixer, powder to be mixed with liquid flowing into the mixer, preferably at a point upstream of the inducer, and preferably via a simple conduit having a feed port for the powder, and preferably along a horizontal flow path, may be readily-drawn into the liquid.

Previous attempts to add powders into liquids using only a rotor-stator mixer have not provided anywhere near satisfactory results for this application. However, this invention has proved capable of transforming the mixing performance such that powder may be absorbed into the liquid at a very rapid rate.

The inducer may act as a small booster pump to help quickly draw powder into the fluid, and may also help to overcome pressure drops that may arise when mixing high viscosity fluids.

According to another aspect of the invention there may also be provided a fluid mixed with a supply of component using an apparatus as described herein.

According to another aspect of the invention there may also be provided a fluid mixed with a supply of component using a method as described herein.

As used herein, the term “inducer” preferably connotes: any component that raises the inlet head; or serves to reduce cavitation, or any component that pumps without significant centrifugal effect. An inducer screw is a type of inducer, for example.

As used herein, the term “helical inducer” preferably connotes an axial flow impeller having one or more blades that wrap in a helix around a central hub.

As used herein, the terms “upstream” and “downstream” preferably connotes may be understood generally to be relative terms referring either to a point in a fluid flow before it has reached a particular feature (“upstream”) or to a point in the fluid flow after it has passed the particular feature (“downstream”) of the apparatus.

As used herein, the term “shaft” preferably connotes any type of axle or similar rotatable member on which a rotor may be mounted and/or by which the rotor may be rotated.

As used herein, the term “fluid” preferably connotes a liquid.

As used herein, the term a “component” or “ingredient” (to be added to a fluid) preferably connotes a gas, liquid or solid, although the invention may be particularly advantageous for mixing a powder into a liquid.

As used herein, the term “immediately” preferably connotes that no other component is introduced into the fluid prior to the inducer, though it will be understood that immediately does not preclude the component being introduced into the fluid at a position that is spaced from the inducer.

Any apparatus feature as described herein may also be provided as a method feature, and vice versa. As used herein, structural features may be expressed alternatively in terms of means plus function.

Any feature in one aspect of the invention may be applied to other aspects of the invention, in any appropriate combination. In particular, method aspects may be applied to apparatus aspects, and vice versa. Furthermore, any, some and/or all features in one aspect can be applied to any, some and/or all features in any other aspect, in any appropriate combination.

It should also be appreciated that particular combinations of the various features described and defined in any aspects of the invention can be implemented and/or supplied and/or used independently.

### BRIEF DESCRIPTION OF DRAWINGS

An example of the present invention will now be described with reference to the accompanying figures, in which:

FIG. 1 shows an in-line mixing apparatus in an exemplary process;

FIG. 2 shows an embodiment of an apparatus for high-shear mixing of a fluid;

FIG. 3 shows another embodiment of an apparatus for high-shear mixing of a fluid;

FIG. 4 shows a forward end view of an apparatus;

FIGS. 5a to 5d each show an example of a stator; and

FIGS. 6a and 6b show two different examples of a rotor.

### DESCRIPTION OF EMBODIMENTS

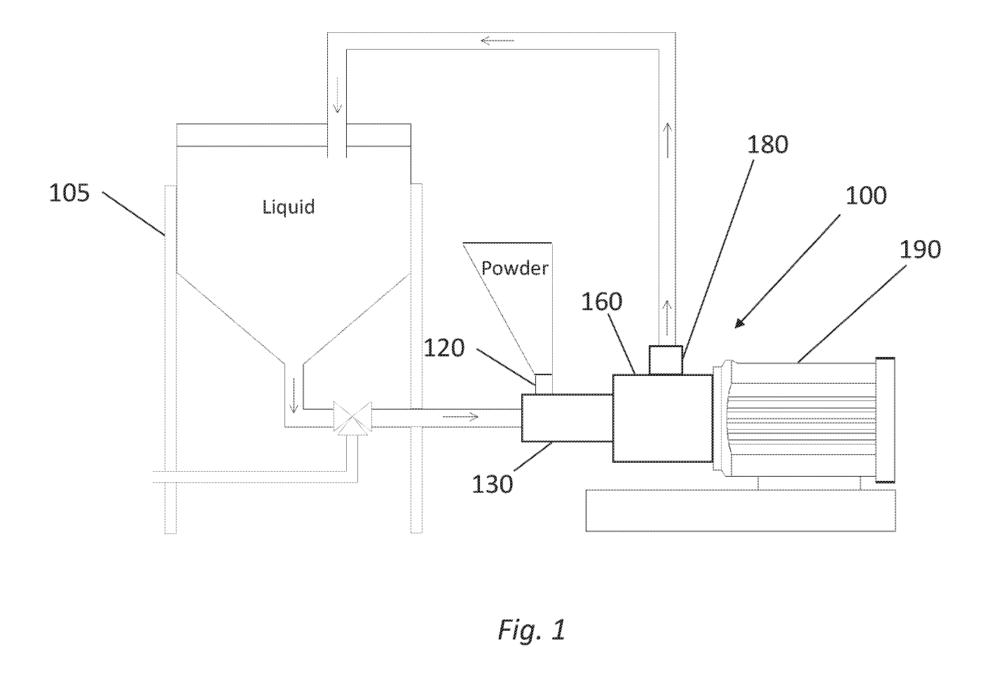

FIG. 1 shows an example of an in-line mixer apparatus 100, wherein a fluid (shown by arrows) to be mixed is continuously drawn from a reservoir 105 into the apparatus 100 via a fluid conduit 130. A component (or ingredient) to be mixed into the fluid is introduced into the fluid via a component inlet 120 arranged upstream of the housing 160. Upon entering the housing 160, the fluid and component are thoroughly mixed together, as will be described in detail further on, before the resulting mixture is expelled, typically at high velocity, out of an outlet 180. The apparatus 100 may be rotatably driven by a motor 190.

The mixture may return (i.e. be recirculated) to the fluid reservoir 105 via a further fluid (recirculation) conduit (or pipe), as shown, whereby the mixing cycle may continue until a desired mixture (or dispersion) is obtained. Alternatively, the mixing cycle could be part of an ongoing process, whereby the mixture simply passes to the next stage to be processed further.

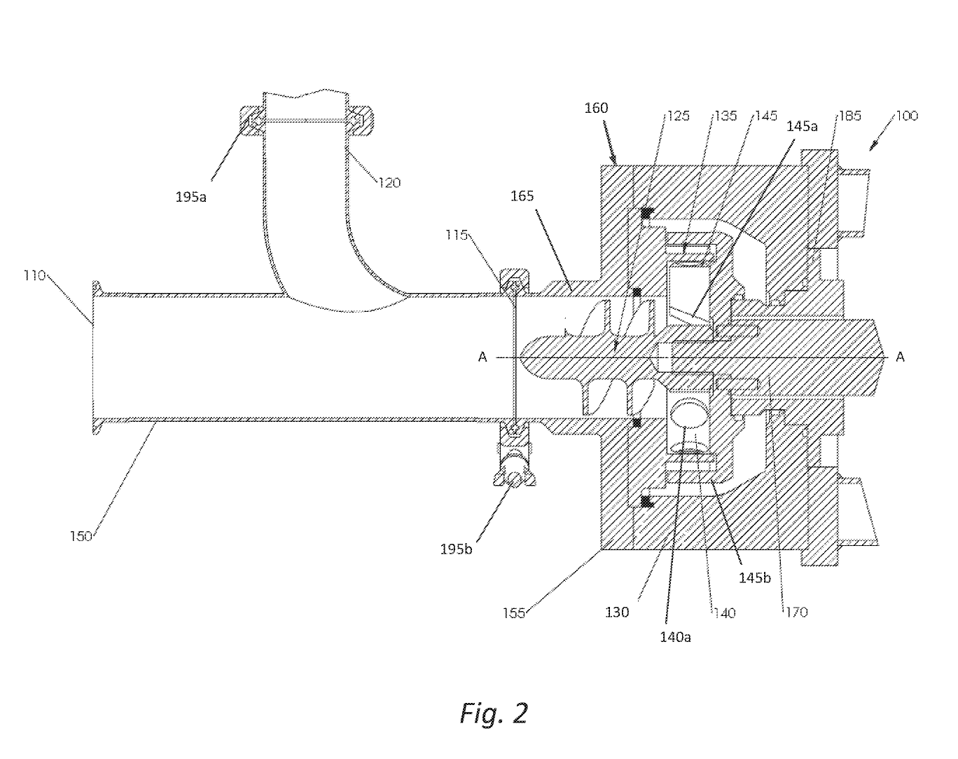

FIG. 2 shows an apparatus 100 for high-shear mixing of a component into a fluid. In particular, the apparatus 100 may be used to mix a powder into a liquid. The apparatus 100 may be particularly beneficial for mixing a high viscosity component into a low viscosity component. It may also have other beneficial uses, such as mixing two viscous fluids, for example.

The housing 160 comprises a main body 130 arranged to provide a cavity, and an inlet body 155 that closes off the cavity. The inlet body 155 may further comprise a fluid inlet 165 arranged to allow fluid to enter the housing 160.

A mixing assembly 135 for mixing the fluid and component together is contained within the cavity formed by the main body 130 and the inlet body 155, such that fluid entering the housing 160 through the inlet 165 must pass through the mixing assembly 135 before it can exit the housing 160. The mixing assembly 135 includes a stator 140 and a rotor 145. The stator 140 is secured to the inlet body 155 within the housing 160. The rotor 145 is arranged to be rotated relative to the stator 140, and is further configured to be mounted on a rotatable shaft 170, which is driven by a motor (not shown).

Such a mixing assembly 135 may be referred to as a ‘rotor-stator’ mixing assembly 135, and is well known. The rotor 145 comprises an arrangement of blades (or vanes) 145a arranged to fit within the stator 140. In FIG. 2, the mixing assembly 135 is illustrated to show part of the rotor 145 having inner blades 145a and outer blades 145b above line A-A, and part of the stator 140 having a plurality of circular apertures 140a below line A-A.

It has been found that a rotor-stator mixing assembly 135 can facilitate mixing of a component (or ingredient) into a fluid with which the component would normally not readily mix. The rotor-stator mixing assembly 135 achieves this mixing by creating high levels of shear in the fluid solution. The component being mixed into the fluid may be in solid, liquid or gaseous form. Such a high-shear mixer apparatus 100 can provide fast, uniform mixing, yielding a consistently homogenous output that may have many practical applications, including food preparation, cosmetics and pharmaceutical, beverages and brewings, chemical and petrochemicals, and agrochemicals.

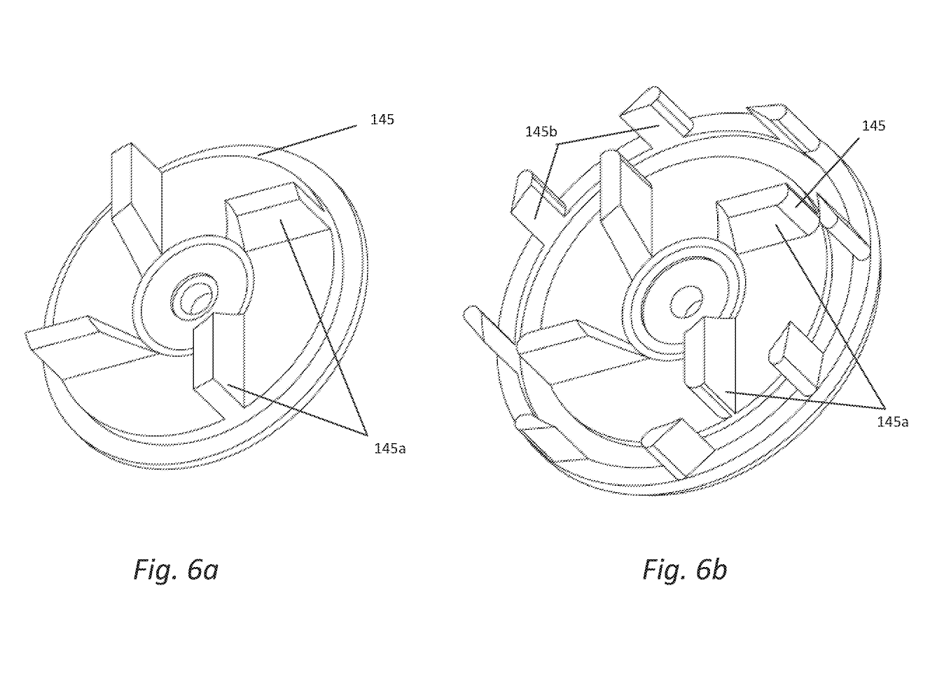

The mixing assembly 135 may comprise a single-stage rotor, which simply mixes the fluid, or a multi-stage rotor, which together with a stator 140 acts to accelerate fluid flow through the mixing assembly 135 and hence through the housing 160. These two different types of rotor, and their interaction with a stator, will be described in further detail later on, with reference to FIGS. 6a and 6b.

As shown in FIG. 2, the stator 140 is fixed, at least in a rotational sense, to the inlet 155 of the housing 160 and the rotor 145 is mounted to a rotatable shaft 170 that is driven by a motor (not shown). In this embodiment, the rotor is a multi-stage rotor, having blades (or vanes) 145a arranged to rotate inside of the stator 140 and blades (or vanes) 145b to rotate outside of the stator 140. The shaft 170 extends through the main body 130 into the housing 160 though a port 165. A sealing member 185 may be provided where the shaft 170 passes through the main body 130 into the housing 160 to ensure a fluid-tight seal. The other end of the shaft 170 is mounted to a motor (not shown).

In addition to the mixing assembly 135, an inducer 125 is also provided in the housing 160, disposed in the port 165 upstream of the mixing assembly 135. The inducer 125 is thereby arranged to be upstream (i.e. ahead or in front) of the mixing assembly 135 in a fluid flow.

The inducer 125 is coaxial with the rotor 145 and is arranged to rotate in unison with the rotor 145. The inducer 125 in this embodiment is a ‘helical’ inducer, which may be described as an axial flow impeller having one or more blades wrapped in a helix around a central hub.

As it rotates, the inducer 125 creates a pressure differential that draws fluid inwardly, towards the housing 160. The inducer 125 may therefore also serve as a small booster pump to reduce a net positive suction head (NPSH) required by the mixing assembly 135, which can furthermore reduce cavitation in the fluid, which can inadvertently be introduced with the powder.

A fluid conduit 150 is attached to the port 165 of the inlet body 155, the fluid conduit 150 being a substantially straight pipe having a first end 110 arranged to receive a fluid and an opposing second end 115 that is fluidly connected to the port 165. A further component inlet 120 is provided in the side of the fluid conduit 150. The further component inlet 120 may be arranged to receive a gravitational feed of a component (or ingredient), for example, from a hopper or another suitable container, such as a so-called “big bag” (not shown), as commonly described in the mixing industry (and for example containing 1 tonne of powder), having a connector that can be attached to the component inlet 120 via a clamp 195a, though other means for securing a container (not shown) are of course possible.

The further component inlet 120 is spaced between the first end 110 and the second end 115 of the fluid conduit 150 and hence from the port 165 of the housing 160. The fluid conduit 150 and housing 160 are, preferably, arranged horizontally, in use, such that fluid flowing through the fluid conduit 150 will enter the housing generally horizontally. Indeed, the entire apparatus 100 is, preferably, arranged horizontally as shown in the figures.

The fluid conduit 150 may be attached to the port 165 and secured by a clamp 195b, though other means for securing the fluid conduit 150 are of course possible. In another embodiment (not shown) the housing 160 could provide a protruding portion in place of the pipe 150, with the further component inlet 120 provided in the protruding portion.

Importantly, the further inlet 115 is arranged upstream of the inducer 125 and hence mixing assembly 135 in the housing 160.

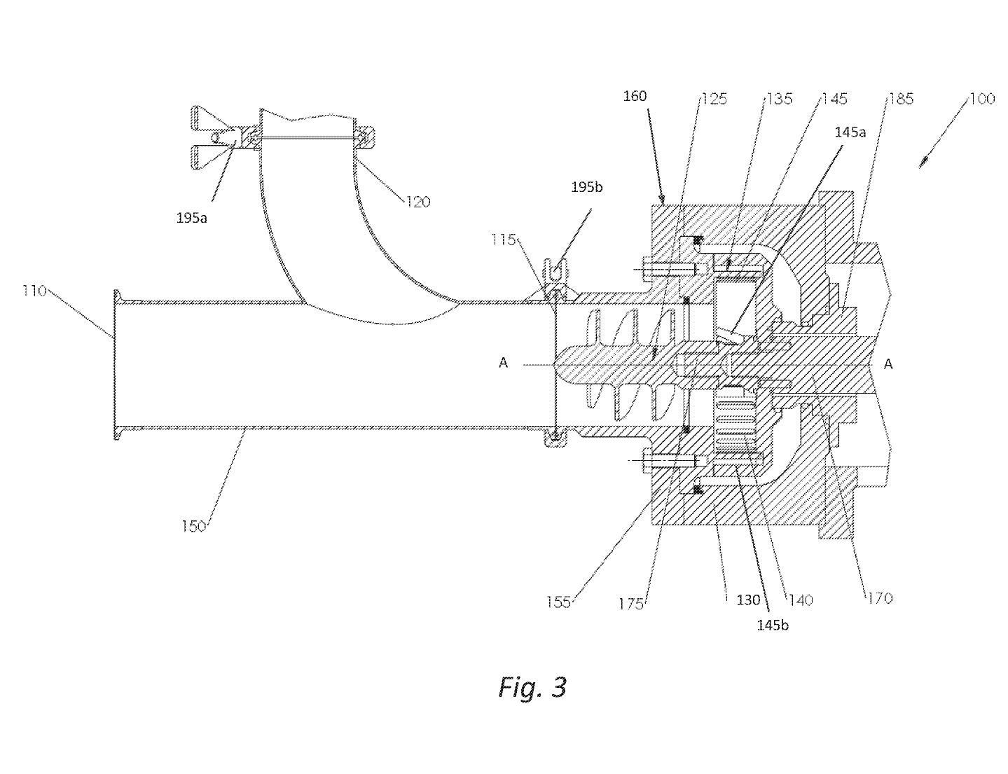

FIG. 3 shows essentially the same arrangement of an apparatus 100 as FIG. 2. The exception is that, rather than being mounted directly to the shaft 170, the inducer 125 is instead mounted to a stub axle 175 provided as part of the rotor 145, which is in turn mounted to the shaft 170, such that the inducer 125 may be rotated in unison with the shaft 170. Additionally, the stator 140 has elongate slots 140d.

FIG. 3 also shows the reverse sides of clamp 195a, which may be used to secure a connector of a “big bag” of component (such as powder) or a hopper to the component inlet 120 of the pipe 150, and of clamp 195b, which may be used to secure the pipe 150 to the housing 130.

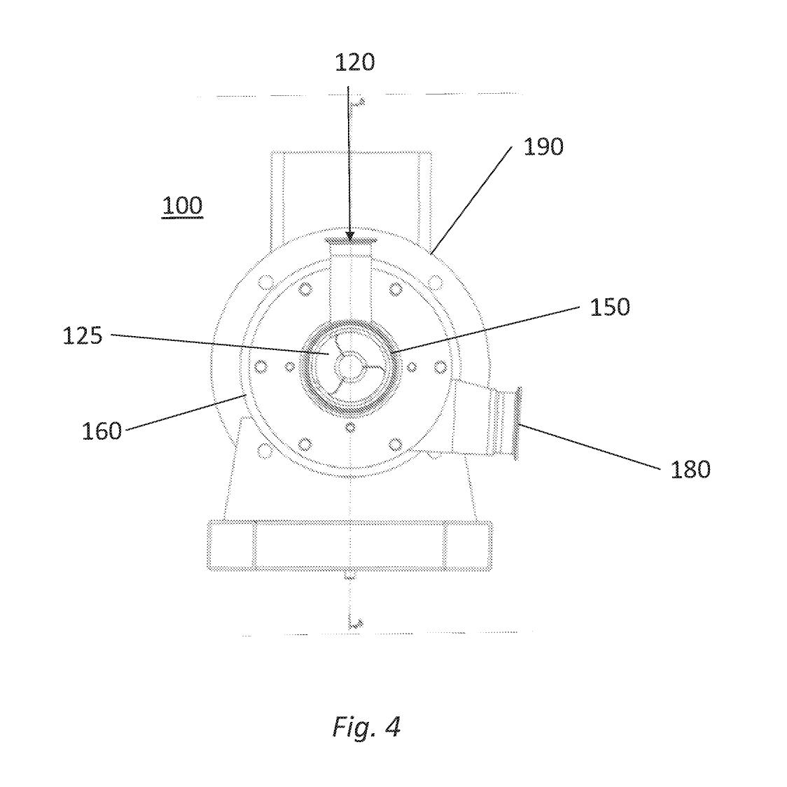

FIG. 4 shows a front end view of the apparatus 100, with the outlet 180 extending out sideways from the housing 160 behind (downstream of) the mixing assembly 135. This outlet 180 cannot be seen in FIG. 2 or 3 due to the cut-away showing the mixing assembly 135. The further component inlet 120 can also be seen provided in the fluid conduit 150 that is attached to the inlet body 155 of the housing 160. The inducer 125 can be seen through the pipe 150, spaced from the further component inlet 120. The housing 160 is substantially cylindrical.

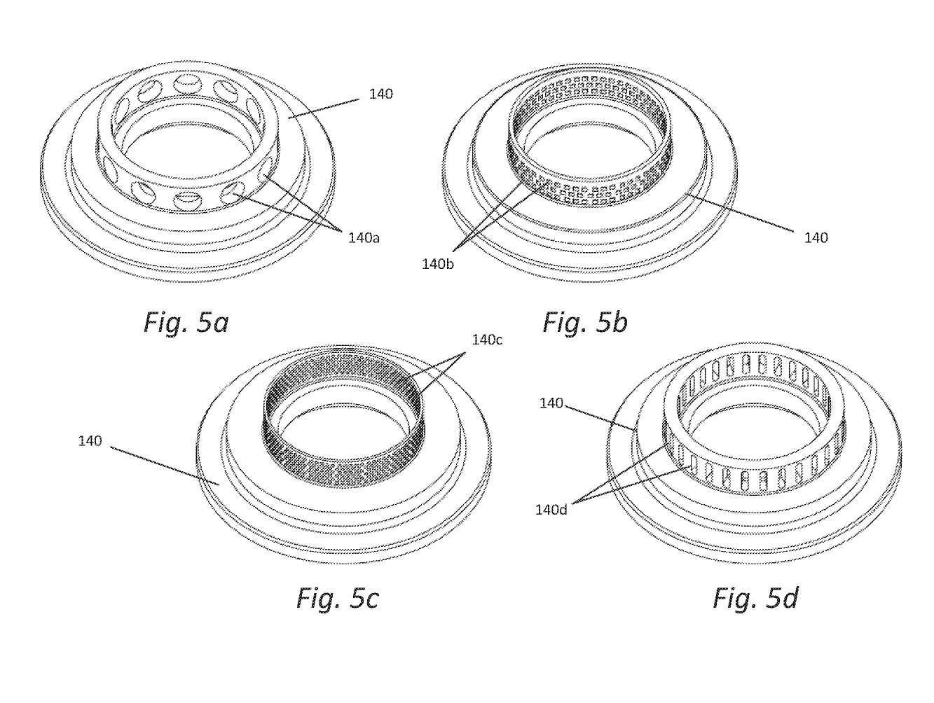

FIGS. 5a to 5d show four examples of a substantially circular stator 140 that might be used in a rotor-stator mixing assembly 135. FIG. 5a shows a stator 140 having a plurality of circular apertures 140a for fluid to pass through; FIG. 5b shows a stator 140 having a plurality of small square apertures 140b for fluid to pass through; FIG. 5c shows a stator 140 having a relatively high number of smaller apertures 140c, compared with FIG. 5b; and FIG. 5d shows a stator 140 having a plurality of elongate slots 140d around its periphery.

The stators 140 may be designed to maximise the throughput of fluid through a mixing assembly, and may be suitable both for mixing two liquids, and also for mixing a solid material into a liquid.

FIGS. 6a and 6b show, respectively, a single-stage rotor and a multi-stage rotor, as mentioned above. The single-stage rotor in FIG. 6a has a single arrangement of blades (or vanes) 145a configured to rotate within a stator, to create high-shear in a fluid and thereby promote mixing, whereby the mixture is forced out of the mixing assembly 135 through the apertures 140a-140d of the stator 140. In addition to the blades 145a of the single-stage rotor, the multi-stage rotor in FIG. 6b has a further array of blades 145b arranged to rotate outside of the stator 140, thereby to provide a pumping action that accelerates fluid flow through the mixing assembly 135.

In addition to enabling a fluid to be pumped further from the apparatus 100, a mixing assembly 135 using a multi-stage rotor 145 also allows the apparatus to be used with mixtures of higher viscosity than for a single-stage rotor. Stators and rotors such as those described herein are well known in the mixing industry.

It will be understood that the present invention has been described above purely by way of example, and modifications of detail can be made within the scope of the invention.

Each feature disclosed in the description, and (where appropriate) the claims and drawings may be provided independently or in any appropriate combination.

Reference numerals appearing in the claims are by way of illustration only and shall have no limiting effect on the scope of the claims.

1. An apparatus for high-shear mixing of a fluid, comprising:
a mixing assembly, optionally including a rotor and a stator; and
an inducer arranged to be in-line with and upstream of the mixing assembly, whereby a fluid to be mixed can pass the inducer before reaching the mixing assembly.

2. An apparatus according to claim 1, further comprising a fluid conduit arranged to introduce fluid into the mixing assembly via the inducer.

3. An apparatus according to claim 2, wherein the fluid conduit is arranged to introduce fluid to the inducer along a generally horizontal flow path.

4. An apparatus according to claim 2, wherein the fluid conduit is further arranged to introduce a component to be mixed with the fluid into the fluid upstream of the inducer.

5. An apparatus according to claim 4, wherein the fluid conduit is arranged such that the component can be introduced into the fluid via a gravitational feed.

6. An apparatus according to claim 4, wherein the fluid conduit is arranged to introduce a component into the fluid immediately upstream of the inducer.

7. An apparatus according to claim 4, wherein the fluid conduit is arranged to introduce a component into the fluid at a distance from the inducer that is less than about double the length of the inducer.

8. An apparatus according to claim 4, further comprising a hopper arranged to introduce the component into the fluid conduit, for example wherein the component is a powder.

9. An apparatus according to claim 1, further comprising a housing for the mixing assembly, the housing having a fluid inlet and a fluid outlet, wherein the mixing assembly is arranged within the housing between the fluid inlet and fluid outlet.

10. An apparatus according to claim 9, wherein the mixing assembly and inducer are both arranged within the housing such that the inducer is upstream of the mixing assembly with respect to the fluid inlet.

11. An apparatus according to claim 10, wherein the inducer is positioned at the fluid inlet of the housing.

12. An apparatus according to claim 11, wherein the fluid conduit is fluidly connected to the fluid inlet of the housing.

13. An apparatus according to claim 12, wherein the fluid conduit is attached directly to the fluid inlet of the housing.

14. An apparatus according to claim 1, wherein the inducer is a helical inducer.

15. An apparatus according to claim 1, wherein the inducer is coaxial with the mixing assembly.

16. An apparatus according claim 1, wherein the inducer and rotor of the mixing assembly are arranged to be rotated in unison.

17. An apparatus according to claim 1, further comprising a shaft, wherein the rotor is mounted to the shaft so as to be rotatable relative to the stator for the purpose of mixing the fluid.

18. An apparatus according to claim 17, wherein the inducer is mounted onto the shaft to which the rotor is mounted.

19. An apparatus according to claim 17, wherein the rotor is provided with a stub axle to which the inducer is mounted.

20. A method for high-shear mixing of a fluid, comprising:
providing a mixing assembly, optionally including a rotor and a stator; and
arranging an inducer in-line with and upstream of the mixing assembly, whereby a fluid to be mixed can pass the inducer before reaching the mixing assembly.

21. (canceled)

22. (canceled)

23. (canceled)

24. (canceled)

25. (canceled)

26. (canceled)

27. (canceled)

28. (canceled)

29. A system for high-shear mixing of a fluid, comprising:
an apparatus according to claim 1; and
a powder for mixing with the fluid.

30. (canceled)
